(19) United States
(12) Patent Application Publication
(10) Pub. No.: US 2026/0341824 A1
(43) Pub. Date: Oct. 29, 2026

(54) A METHOD FOR RECOVERING METALS FROM BLACK MASS FROM RECYCLING OF SPENT LITHIUM-ION BATTERIES

(71) Applicant: ELION SP. Z O.O., Legionowo (PL)

(72) Inventors: Dariusz Bradlo, Miechow (PL); Barbara Tarko, Miechow (PL); Katarzyna Pieta, Zabrze (PL); Szymon Wojciechowski, Zabrze (PL); Anita Staron, Krakow (PL); Pawel Staron, Krakow (PL); Jaroslaw Chwastowski, Krakow (PL); Piotr Radomski, Krakow (PL)

(73) Assignee: ELION SP. Z O.O., Legionowo (PL)

(21) Appl. No.: 19/116,203

(22) PCT Filed: Sep. 30, 2022
(86) PCT No.: PCT/PL2022/050059

§ 371 Date: Mar. 27, 2025

(51) Int. Cl. H01M 10/54; C22B 3/00; C22B 3/42; C22B 3/46; C22B 7/00; C22B 15/00; C22B 26/12; C22B 47/00; H01M 10/0525

(52) U.S. Cl. CPC H01M 10/54; C22B 3/42; C22B 3/46; C22B 7/007; C22B 15/0091; C22B 23/043; C22B 23/0492; C22B 26/12; C22B 47/00; H01M 10/0525

(57) ABSTRACT

A method for recovering metals from black mass from recycling of spent lithium-ion batteries, characterized in that it comprises the following steps:
a) leaching the black mass with sulfuric acid (VI) with the addition of H₂O₂ in order to obtain an extract comprising metals;
b) adding iron dust to the extract in order to cement copper and then separating the precipitated copper from the extract;
c) adding a manganese oxidizing agent to the extract and then separating the resulting MnO₂ from the extract;
d) alkalizing the extract in order to precipitate iron (III) hydroxide or iron (III) oxyhydroxide or a mixture thereof and then separating the resulting precipitate from the extract;
e) alkalizing the extract in order to precipitate nickel (II) hydroxide and cobalt (II) hydroxide, or nickel (II) carbonate and cobalt (II) carbonate, separating the resulting precipitate from the extract to obtain a lithium-containing solution, solubilizing the separated precipitate in hydrochloric acid and then selectively separating nickel ions and cobalt ions from the obtained solution in a column filled with ion exchange resin, wherein the elution of nickel ions is carried out with a hydrochloric acid solution, and the elution of cobalt ions is carried out with water, to obtain a nickel ions solution and a cobalt ions solution, followed by adding oxalate solution to the obtained nickel ion solution and cobalt ion solution in order to precipitate nickel oxalate and cobalt oxalate, and then separating nickel oxalate and cobalt oxalate from the obtained solution to obtain a lithium solution;
f) evaporating the lithium-containing solution obtained in step e) in order to reduce the volume, adding a solution of salt of phosphoric acid or carbonic acid or carbon dioxide to the lithium-containing solution in order to precipitate lithium phosphate (V) or lithium carbonate and then separating the resulting precipitate from the solution.

### DESCRIPTION OF THE INVENTION

The invention relates to a method for recovering metals from black mass from recycling of spent lithium-ion batteries. The invention makes it possible to recover valuable elements from waste lithium-ion batteries in a safe and eco-friendly manner and provides high-efficient recovery of valuable elements, such as lithium, cobalt, manganese and nickel.

### BACKGROUND ART

Due to a limited number of recharge cycles in lithium-ion batteries, such batteries are expected to become a significant component of the waste stream, because many devices, such as electric cars and laptops, will reach the end of their service life. The recycling of spent lithium-ion batteries enables reducing the amount of this type of waste and contributes to a decrease in the extraction of the respective elements. In view of increased demand for the production of lithium-ion batteries, the recycling of lithium and other metals (cobalt, nickel, manganese, iron) used in the production process of new batteries will make it possible to substantially reduce the demand for these metals. The extraction and processing of metals has a much greater negative impact on the environment than the recycling process. The recovery of valuable elements from spent lithium-ion batteries not only contributes to the protection of the environment and reduction in energy consumption, but due to the use of the recovered metals can contribute to lower cost of new batteries.

In technology, there are three methods of/for the recycling lithium-ion (Li-ion) batteries: the pyrometallurgical method, hydrometallurgical method and direct recycling. The direct recycling method involves dismantling the batteries and then reusing individual components of the cell, including both the cathode and the anode. At present this approach is still in the research phase and it has not been used on a large scale, yet. The pyrometallurgical method involves the high-temperature treatment of Li-ion batteries and results in production of an alloy containing, inter alia Co, Cu, Fe and Ni. In this way, it is not possible to recover most of the material present in the battery (graphite, electrolyte, lithium, etc.). The hydrometallurgical method involves use of an aqueous environment to separate valuable chemical elements from the cathode of spent Li-ion batteries. The major advantages of this method are the possibility of recovering multiple components of spent Li-ion batteries as well as relatively low temperatures of the process. Hydrometallurgical methods differ from one other as regards the implementation of individual steps of the process, the type and quality of resulting products, and the degree of recovery of valuable materials. However, all these methods consist of two main steps: the process of shredding the batteries with mechanical separation methods and the process of chemical processing of a fraction containing valuable metals to recover them. Study is continued on this process to implement it on an industrial scale for Li-ion batteries comprising different cathodes. The process also has to be economically viable as well as it should meet environmental requirements. Currently, there is no solution that would meet all these conditions simultaneously.

WO 2021/018372 A1 discloses a solution in which the leaching process is carried out with the use of concentrated sulfuric acid (VI) at a temperature above 100 °C, while the processes of separation of individual chemical elements are based on a multistage solvent extraction.

The issue concerning the formation of cobalt (II) chloride complexes in hydrochloric acid environment and sorption of the formed ions on an anionic ion exchange resin is known from the literature (M. Uchikoshi, Journal of Solution Chemistry, 2018, 47, 2021-2038). However, using that method to separate Ni (II) ions from Co (II) ions, including those ions present in a solution during the process of recycling lithium-ion batteries, is not known.

EP 3535803 B1 discloses a method for recovering metals from the black mass derived from spent lithium-ion batteries, using inter alia organic extractants. WO 2018/223193 A1 discloses a method for recovering metals from lithium-ion batteries. In this method, the extraction of metals is carried out in an SO₂ gas environment.

### SUMMARY OF THE INVENTION

The invention relates to a method for recovering metals from black mass from recycling of spent lithium-ion batteries, characterized in that it comprises the following steps:
(a) leaching the black mass with sulfuric acid with the addition of H₂O₂ to obtain an extract comprising metals;
b) adding iron dust to the extract in order to cement copper and then separating the precipitated copper from the extract;
c) adding a manganese oxidizing agent to the extract and then separating the resulting MnO₂ from the extract;
d) alkalizing the extract in order to precipitate iron (III) hydroxide or iron (III) oxyhydroxide or a mixture thereof and then separating the resulting precipitate from the extract;
e) alkalizing the extract in order to precipitate nickel (II) hydroxide and cobalt (II) hydroxide, or nickel (II) carbonate and cobalt (II) carbonate, separating the resulting precipitate from the extract to obtain a lithium-containing solution, solubilizing the separated precipitate in hydrochloric acid and then selectively separating nickel ions and cobalt ions from the obtained solution in a column filled with an ion exchange resin, wherein the elution of nickel ions is carried out with a hydrochloric acid solution, and the elution of cobalt ions is carried out with water, to obtain a nickel ions solution and a cobalt ions solution, followed by adding an oxalate solution to the obtained nickel ion solution and cobalt ion solution in order to precipitate nickel oxalate and cobalt oxalate, and then separating nickel oxalate and cobalt oxalate from the obtained solution to obtain lithium solution;
f) evaporating the lithium-containing solution obtained in step e) in order to reduce the volume, adding a solution of salt of phosphoric acid or carbonic acid or carbon dioxide to the lithium-containing solution in order to precipitate lithium phosphate (V) or lithium carbonate and then separating the resulting precipitate from the solution.

In a preferred variant of the method, the raw material is the black mass derived from grinding various types of lithium-ion batteries.

Preferably, the process of leaching the black mass is carried out with the use of H₂SO₄ having a concentration of 0.5-18 M, solid:acid ratio=20:1-200:1 g/L, at a temperature of 20-100 °C, with the addition of 5-40 volume % of 30-60% H₂O₂, for 30-300 minutes.

Preferably, in step a) cementation is carried out with the use of iron dust having the grain diameter of 0.02-2 mm, with Fe:Cu molar ratio=1-6, pH=0-2, at a temperature of 20-80 °C, for 10-100 min.

Preferably, in steps d) and e) the alkalizing of the extract is carried out using NaOH solution having a concentration of 10 to 50 weight % or Na₂CO₃ solution having a concentration of 5-20 weight % or NH₃ aq. solution having a concentration of 5-30 weight %.

Preferably, in step c) the manganese oxidizing agent is solid KMnO₄ and KMnO₄ to Mn²⁺ molar ratio in the extract is from 0.2 to 1.0, and the process is carried out for 10-120 min. Preferably, in step e) the precipitate of nickel and cobalt is solubilized with HCl having a concentration of 25-38%, at the precipitate:acid ratio=1:10-1:50 g/mL.

Preferably, in step e) the column for separating nickel ions from cobalt ions comprises a strongly basic ion exchange resin in the chloride form.

Preferably, in step e) the separation of cobalt from nickel is carried out in a manner ensuring contact of the cobalt solution with the bed for 20-90 min.

Preferably, in step e) the HCl solution recycled from the separation process in the column is used to solubilize the precipitate of nickel and cobalt.

Preferably, in step e) the oxalate solution added in order to precipitate nickel oxalate and cobalt oxalate is a solution of oxalic acid or sodium oxalate or ammonium oxalate.

Preferably, in step f) the evaporation to reduce the volume of the lithium-containing solution is carried out at a temperature of 80-99 °C with continuous mixing at 100-1000 rpm until 10-95% of the initial volume is obtained.

Preferably, in step f) the process of lithium precipitation is carried out at a temperature of 60-90 °C, for 5-120 min, with the use of Na₃PO₄ or Na₂CO₃ or CO₂.

Preferably, in step f) the process of lithium precipitation is carried out using the molar ratio of the precipitating agent to lithium ions of 1.0-2.0.

The black mass shall be understood to mean ground cathodes and anodes, consisting of graphite and metals, in particular: lithium, cobalt, nickel and manganese. The black mass also includes fragmented metals (iron, copper, aluminum and others) present in batteries.

The methods for recovery of valuable metals described in the prior art, unlike the method of the present invention, are characterized by a high level of complexity as well as high costs, which significantly limits their use on an industrial scale. The method of the present invention enables the transfer of valuable metals present in spent batteries into a solution at high efficiency as well as highly efficient and selective recovery of metals such as lithium, cobalt, nickel and manganese. Furthermore, this method is characterized by the use of moderate temperatures, common reagents and does not require the use of organic solvents.

### EMBODIMENTS OF THE INVENTION

The invention is illustrated by the following examples.

### Example 1

4.0 L of 2 M sulfuric acid (VI) was introduced into a reactor and was heated to 80 °C, then 400 g of the black mass was added and the mixture was mixed using a mechanical stirrer (200 rpm). After 30 minutes of mixing, dosing of 20 volume % of 30% H₂O₂ was started (dosing during 2 h); after dosing was completed, the suspension was mixed for 30 min. After the process of leaching the black mass was completed, the extract was separated from graphite using a filtration method under reduced pressure (4×10-2 mbar). 4900 mL of the extract was obtained, which was used in further steps to recover valuable elements. The first step of metals recovery was the introduction of 12 g of iron dust (0.02 mm) into the extract, corresponding to the Fe:Cu ratio of 4:1. The cementation process was carried out at the temperature of 30 °C for 80 min at pH=0. After the cementation was completed, the copper precipitated on the iron dust was separated under reduced pressure (4×10⁻² mbar) to obtain 10 g of the material. After cementation, dosing of 20 weight % NaOH solution to the extract was started. 84 g of solid KMnO₄ (KMnO₄ to Mn²⁺ molar ratio in the extract=0.5) was added to the solution at pH=2, and the mixture was mixed for 30 min. Then the resulting MnO₂ was separated from the solution under reduced pressure (4×10⁻² mbar). 1300 g of MnO₂ and 4900 mL of solution were obtained. The solution was adjusted to pH=4 (using 20 weight % NaOH) and the resulting precipitate of iron (III) hydroxide and iron (III) oxyhydroxide was separated under reduced pressure (4×10⁻² mbar). 50 g of the precipitate and 5200 mL of the solution were obtained. Then, the obtained solution was neutralized with 20 weight % NaOH to pH=10. The resulting precipitate of nickel (II) hydroxide and cobalt (II) hydroxide was separated under reduced pressure (4×10⁻² mbar) from the solution (which included mainly lithium). 1100 g of the precipitate and 4600 mL of the solution were obtained. 2500 mL of 35% HCl (precipitate:acid ratio=1:10 g/mL) was added to the dried precipitate and the mixture was mixed until the precipitate was completely solubilized. Then, the solution was introduced into a column filled with ion exchange resin (strongly basic, substituted with Cl-ions) and filled with 35% HCl. The column retained the cobalt ions and the nickel ions left the column first. To recover metal ions, 35% HCl was added to elute the nickel ions, and subsequently H₂O was added to recover the cobalt ions. The flow of the solution through the column was adjusted to reach the average residence time in the column of 35 min. 55 g of ammonium oxalate (oxalate ions to nickel ions molar ratio=1.2) was added to the nickel solution, and 110 g of ammonium oxalate was added to the cobalt solution (oxalate ions to cobalt ions molar ratio=1.2). Finally, 100 g of cobalt oxalate precipitate and 60 g of nickel oxalate precipitate were obtained. The resulting lithium solution was evaporated to 50% of the initial volume (95 °C, 500 rpm); then, after cooling to 85 °C, 300 g of Na₃PO₄·12H₂O (phosphate (V) ions to lithium ions molar ratio=1.5) was added and mixed for 30 min (300 rpm). After that time, the resulting precipitate of lithium phosphate (V) was separated from the solution by hot filtration (85 °C) under reduced pressure (4×10⁻² mbar). 170 g of lithium phosphate (V) precipitate was obtained.

### Example 2

2.0 L of 4 M sulfuric acid (VI) was introduced into a reactor and was heated to 90 °C, then 400 g of the black mass was added and the mixture was mixed using a mechanical stirrer (300 rpm). After 15 minutes of mixing, dosing of 40 volume % of 30% H₂O₂ was started (dosing during 3 h); after dosing was completed, the suspension was mixed for 45 min. After the process of leaching the black mass was completed, the extract was separated from graphite using a filtration method under reduced pressure (4×10⁻² mbar). 2600 ml of the extract was obtained, which was used in further steps to recover valuable elements. The first step of metals recovery was the introduction of 15 g of iron dust (0.02 mm) into the extract, corresponding to Fe:Cu ratio=5:1. The cementation process was carried out at 60 °C for 20 minutes at pH=1. After cementation was completed, the copper precipitated on the iron dust was separated under reduced pressure (4×10⁻² mbar) to obtain 13 g of the material. After cementation, dosing of 45 weight % NaOH solution to the extract was started. 100 g of solid KMnO₄ (KMnO₄ to Mn²⁺ molar ratio in the extract=0.6) was added to the solution at pH=2, and the mixture was mixed for 90 min. Then, the resulting MnO₂ was separated from the solution under reduced pressure (4×10⁻² mbar). 1200 g of MnO₂ and 2200 mL of the solution were obtained. The solution was adjusted to pH=4.3 (using 45 weight % NaOH) and the resulting precipitate of iron (III) hydroxide and iron (III) oxyhydroxide was separated under reduced pressure (4×10⁻² mbar). 40 g of the precipitate and 2300 mL of the solution were obtained. Then, the obtained solution was neutralized with 45 weight % NaOH to pH=9. The resulting precipitate of nickel (II) hydroxide and cobalt (II) hydroxide was separated under reduced pressure (4×10⁻² mbar) from the solution (which included mainly lithium). 1000 g of the precipitate and 1600 mL of the solution were obtained. 3000 mL of 30% HCl (precipitate:acid ratio=1:15 g/mL) was added to the dried precipitate and the mixture was mixed until the precipitate was completely solubilized. Then, the solution was introduced into a column filled with an ion exchange resin (strongly basic, substituted with Cl-ions) and filled with 30% HCl. The column retained the cobalt ions, and the nickel ions left the column first. To recover the metal ions, 30% HCl was added to elute the nickel ions, and subsequently H₂O was added to recover the cobalt ions. The flow of solution through the column was adjusted to reach the average residence time in the column of 50 min. 40 g of ammonium oxalate (oxalate ions to nickel ions molar ratio=1.1) was added to the nickel solution, and 80 g of ammonium oxalate was added to the cobalt solution (oxalate ions to cobalt ions molar ratio=1.1). Finally, 75 g of cobalt oxalate precipitate and 45 g of nickel oxalate precipitate were obtained. The resulting lithium solution was evaporated to 90% of the initial volume (95 °C, 500 rpm); then, after cooling to 85 °C, 220 g of Na₃PO₄·12H₂O (phosphate (V) ions to lithium ions molar ratio=1.1) was added and mixed for 10 min (300 rpm). After that time, the precipitate of lithium phosphate (V) was separated from the solution by hot filtration (85 °C) under reduced pressure (4×10⁻² mbar). 180 g of lithium phosphate (V) precipitate was obtained.

### Example 3

8.0 L of 1 M sulfuric acid (VI) was introduced into a reactor and was heated to 70 °C, then 400 g of the black mass was added and the mixture was mixed with a mechanical stirrer (200 rpm). After 45 minutes of mixing, dosing of 5 volume % of 60% H₂O₂ was started (dosing during 4 h); after dosing was completed, the suspension was mixed for 15 min. After the process of leaching the black mass was completed, the extract was separated from graphite using a filtration method under reduced pressure (4×10⁻² mbar). 8.0 L of extract was obtained, which was used in further steps to recover valuable elements. The first step of metals recovery was the introduction of 16 g of iron dust (0.02 mm) into the extract, corresponding to the ratio Fe:Cu=6:1. The cementation process was carried out at 50 °C for 30 minutes at pH=0.5. After cementation was completed, the precipitated copper on the iron dust was separated under reduced pressure (4×10⁻² mbar) to obtain 14 g of the material. After cementation, dosing of 20 weight % NaOH solution to the extract was started. 80 g of solid KMnO₄ (KMnO₄ to Mn²⁺ molar ratio in the extract=0.45) was added to the solution at pH=2.5, and the mixture was mixed for 45 min. Then, the resulting MnO₂ was separated from the solution under reduced pressure (4×10⁻² mbar). 1000 g of MnO₂ and 11.0 L of the solution were obtained. The solution was adjusted to pH=3.8 (using 20 weight % Na₂CO₃ solution) and the resulting precipitate of iron (III) hydroxide and iron (III) oxyhydroxide was separated under reduced pressure (4×10⁻² mbar). 60 g of the precipitate and 11.5 L of the solution were obtained. Then, the obtained solution was neutralized with 20 weight % Na₂CO₃ solution to pH=8.5. The resulting precipitate of nickel (II) carbonate and cobalt (II) carbonate was separated under reduced pressure (4×10⁻² mbar) from the solution (which included mainly lithium). 1300 g of the precipitate and 11.1 L of the solution were obtained. 12 L of 30% HCl (precipitate:acid ratio=1:40 g/mL) was added to the dried precipitate and the mixture was mixed until the precipitate was completely solubilized. Then, the solution was introduced into a column filled with ion exchange resin (strongly basic, substituted with Cl-ions) and filled with 30% HCl. The column retained the cobalt ions, and the nickel ions left the column first. To recover metal ions, 30% HCl was added to elute the nickel ions, and subsequently H₂O was added to recover the cobalt ions. The flow of solution through the column was adjusted to reach the average residence time in the column of 50 min. 70 g of ammonium oxalate (oxalate ions to nickel ions molar ratio=1.3) was added to the nickel solution, and 140 g of ammonium oxalate was added to the cobalt solution (oxalate ions to cobalt ions molar ratio=1.3). Finally, 115 g of cobalt oxalate precipitate and 70 g of nickel oxalate precipitate were obtained. The resulting lithium solution was evaporated to 20% of the initial volume (95 °C, 500 rpm); then, after cooling to 85 °C, 330 g of Na₂CO₃ (carbonate ions to lithium ions molar ratio=2.0) was added and was mixed for 120 min (300 rpm). After this time, the lithium carbonate precipitate was separated from the solution by hot filtration (85 °C) under reduced pressure (4×10⁻² mbar). 110 g of precipitate of lithium carbonate was obtained.

### INDUSTRIAL APPLICABILITY

The invention is applicable to the recycling of spent lithium-ion batteries.

1. A method for recovering metals from black mass from recycling of spent lithium-ion batteries, comprising the following steps:
a) leaching the black mass with sulfuric acid (VI) with the addition of H₂O₂ in order to obtain an extract comprising metals;
b) adding iron dust to the extract in order to cement copper and then separating the precipitated copper from the extract;
c) adding a manganese oxidizing agent to the extract and then separating the resulting MnO₂ from the extract;
d) alkalizing the extract in order to precipitate iron (III) hydroxide or iron (III) oxyhydroxide or a mixture thereof and then separating the resulting precipitate from the extract;
e) alkalizing the extract in order to precipitate nickel (II) hydroxide and cobalt (II) hydroxide, or nickel (II) carbonate and cobalt (II) carbonate, separating the resulting precipitate from the extract to obtain a lithium-containing solution, solubilizing the separated precipitate in hydrochloric acid and then selectively separating nickel ions and cobalt ions from the obtained solution in a column filled with ion exchange resin, wherein the elution of nickel ions is carried out with a hydrochloric acid solution and the elution of cobalt ions is carried out with water, to obtain a nickel ions solution and a cobalt ions solution, followed by adding oxalate solution to the obtained nickel ion solution and cobalt ion solution in order to precipitate nickel oxalate and cobalt oxalate, and then separating nickel oxalate and cobalt oxalate from the obtained solution to obtain lithium solution;
f) evaporating the lithium-containing solution obtained in step e) in order to reduce the volume, adding a solution of salt of phosphoric acid or carbonic acid or carbon dioxide to the lithium-containing solution in order to precipitate lithium phosphate (V) or lithium carbonate and then separating the resulting precipitate from the solution.

2. The method of claim 1, wherein the raw material is the black mass derived from grinding various types of lithium-ion batteries.

3. The method of claim 1, wherein the process of leaching the black mass is carried out with the use of H₂SO₄ having a concentration of 0.5-18 M, solid:acid ratio=20:1-200:1 g/L), at a temperature of 20-100 °C, with the addition of 5-40 volume % of 30-60% H₂O₂, for 30-300 min.

4. The method of claim 1, wherein in step a) cementation is carried out with the use of iron dust having the grain diameter of 0.02-2 mm, with Fe:Cu molar ratio=1-6, pH=0-2, at a temperature of 20-80 °C, for 10-100 minutes.

5. The method of claim 1, wherein in steps d) and e) alkalizing of the extract is carried out using a NaOH solution having a concentration of 10 to 50 weight % or a Na₂CO₃ solution having a concentration of 5-20 weight % or NH₃ aq. solution having a concentration of 5-30 weight %.

6. The method of claim 1, wherein in step c) the manganese oxidizing agent is solid KMnO₄ and KMnO₄ to Mn²⁺ molar ratio in the extract is from 0.2 to 1.0, and the process is carried out for 10-120 min.

7. The method of claim 1, wherein in step e) the precipitate of nickel (II) hydroxide and cobalt (II) hydroxide, or nickel (II) carbonate and cobalt (II) carbonate is solubilized with HCl having a concentration of 25-38%, at the precipitate:acid ratio=1:10-1:50 g/mL.

8. The method of claim 1, wherein in step e) the column for separating nickel ions from cobalt ions contains a strongly basic ion exchange resin in the chloride form.

9. The method of claim 1, wherein in step e) the separation of cobalt from nickel is carried out in a manner ensuring contact of the cobalt solution with the bed for 20-90 min.

10. The method of claim 7, wherein in step e) the HCl solution recycled from the separation process in the column is used to solubilize the precipitate of nickel (II) hydroxide and cobalt (II) hydroxide, or nickel (II) carbonate and cobalt (II) carbonate.

11. The method of claim 1, wherein in step e) the oxalate solution added in order to precipitate nickel oxalate and cobalt oxalate is a solution of oxalic acid or sodium oxalate or ammonium oxalate.

12. The method of claim 1, wherein in step f) the evaporation to reduce the volume of the lithium-containing solution is carried out at a temperature of 80-99 °C with continuous mixing at 100-1000 rpm until 10-95% of the initial volume is obtained.

13. The method of claim 1, wherein in step f) the precipitation process of lithium phosphate (V) or lithium carbonate is carried out at a temperature of 60-90 °C, for 5-120 minutes, with the use of Na₃PO₄ or Na₂CO₃ or CO₂.

14. The method of claim 1, wherein that in step f) the precipitation process of lithium phosphate (V) or lithium carbonate is carried out using a molar ratio of the precipitating agent to lithium ions of 1.0-2.0.

15. The method of claim 3, wherein in step a) cementation is carried out with the use of iron dust having the grain diameter of 0.02-2 mm, with Fe:Cu molar ratio=1-6, pH=0-2, at a temperature of 20-80 °C, for 10-100 minutes.

16. The method of claim 15, wherein in steps d) and e) alkalizing of the extract is carried out using a NaOH solution having a concentration of 10 to 50 weight % or a Na₂CO₃ solution having a concentration 5-20 weight % NH₃ aq. solution having a concentration of 5-30 weight %.

17. The method of claim 16, wherein in step c) the manganese oxidizing agent is solid KMnO₄ and KMnO₄ to Mn²⁺ molar ratio in the extract is from 0.2 to 1.0, and the process is carried out for 10-120 min.

18. The method of claim 17, wherein in step e) the precipitate of nickel (II) hydroxide and cobalt (II) hydroxide, or nickel (II) carbonate and cobalt (II) carbonate is solubilized with HCl having a concentration of 25-38%, at the precipitate:acid ratio=1:10-1:50 g/mL.

19. The method of claim 18, wherein in step e) the column for separating nickel ions from cobalt ions contains a strongly basic ion exchange resin in the chloride form.

20. The method of claim 19, wherein in step e) the separation of cobalt from nickel is carried out in a manner ensuring contact of the cobalt solution with the bed for 20-90 min.
